(19) United States
(12) Patent Application Publication
(10) Pub. No.: US 2011/0222271 A1
(43) Pub. Date: Sep. 15, 2011

(54) TEST PROBE WITH ILLUMINATION

(76) Inventor: SHAW-LIN LIU, Shu Lin City (TW)

(21) Appl. No.: 12/873,321

(22) Filed: Sep. 1, 2010

(30) Foreign Application Priority Data
Mar. 11, 2010 (TW) 099204310

(51) Int. Cl. F21L 4/00

(52) U.S. Cl. 362/157

(57) ABSTRACT

The test probe with illumination for working with various electrical test and measurement devices contains a light generation member to project light in front of a test pin of the test probe so that the test probe could be conveniently operated in the dark. According to the present invention, the light generation member is housed in a chamber of the test probe's body member. The light generation member contains a light generation circuit and a battery pack. The light generation circuit has a light generation element and a switch element with a control means exposed outside the body member. By engaging the control means, the light generation element is turned on and off.

### TECHNICAL FIELD OF THE INVENTION

The present invention generally relates to test probes, and more particular to a test probe equipped with a light generation device to provide illumination when the test probe is operated in an environment of poor lighting.

### DESCRIPTION OF THE PRIOR ART

A test probe is a physical device used to connect electronic test equipment such as a voltmeter, an ammeter, etc., to a device under test (DUT). Conventionally, the test probe contains a metallic test pin wrapped in an insulating material, and the test probe is used to touch an electrical contact point of the DUT to pick up a voltage or current value.

It is not uncommon that the DUT is located in a dark or dimly lit environment and an operator has to rely on additional illumination so as to conduct the measurement, which is quite inconvenient and troublesome.

In addition, for some senior citizen or one with poor eyesight, it would be even more difficult to point the test probe precisely to the right sport when the environment is not well lit.

### SUMMARY OF THE INVENTION

Accordingly, a novel test probe with illumination for working with various electrical test and measurement devices is provided. The test probe contains a light generation member to project light in front of a test pin of the test probe so that the test probe could be conveniently operated in the dark.

According to the present invention, the light generation member is housed in a chamber of the test probe's body member. The light generation member contains a light generation circuit and a battery pack. The light generation circuit has a light generation element and a switch element with a control means exposed outside the body member. By engaging the control means, the light generation element is turned on and off.

Alternatively, the light generation circuit and the battery pack are housed in a casing element and the casing element is in turn accommodated in the body member's chamber. Again, the light generation circuit has a light generation element and a switch element with a control means exposed outside the casing element and the body member. By engaging the control means, the light generation element is turned on and off.

A front opening is provided on a front side of the body member so that the light from the light generation member is allowed to pass through. A light guiding element is positioned between the front opening and the light generation element for focusing and directing the light forward. The light guiding element has a compartment to accommodate the light generation element.

The light generation element is aimed along a first direction while the test pin is extended along a second direction. The first and second directions intersect at a point at a distance ahead of the test pin.

Inside the body member's chamber, threads are provided adjacent to a back opening on a back side of the body member. The back opening is for the placement and replacement of the battery pack and is screwed shut by a plug so as to seal the light generation member inside the chamber.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing the various components of a test probe with illumination according to an embodiment of the present invention.

FIG. 2 is a perspective diagram showing the test probe of FIG. 1 after its assembly.

FIG. 3 is a perspective break-down diagram showing the various components of a test probe with illumination according to another embodiment of the present invention.

FIG. 4 is a cross-sectional diagram showing the test probe with illumination of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

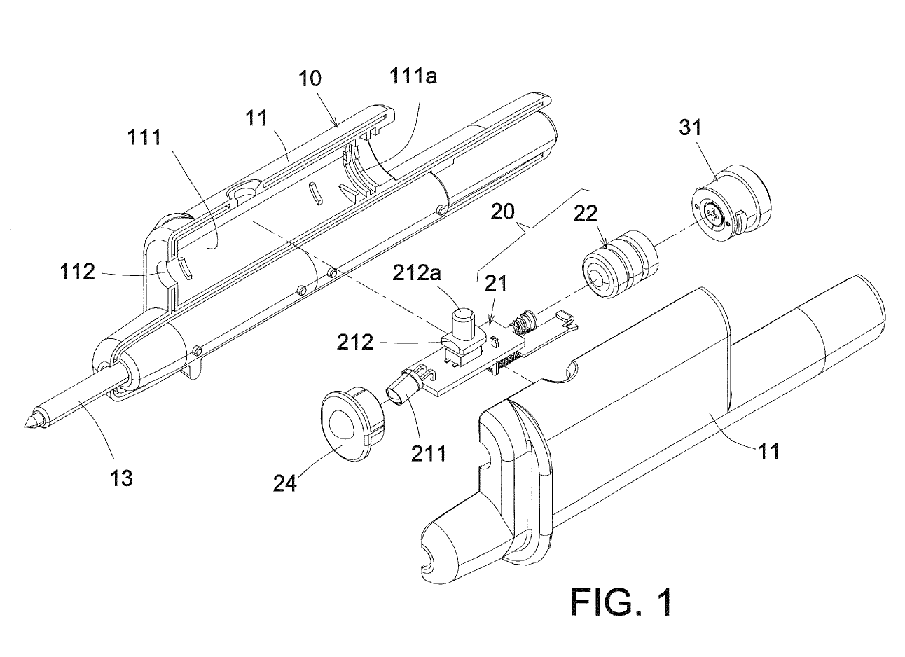

As shown in FIGS. 1 to 4, a test probe 10 according to an embodiment of the present invention contains a body member 11 and a light generation member 20. By the light projected from the light generation member 20 to a device under test (DUT), the test probe 10 could be conveniently operated in an environment of poor lighting.

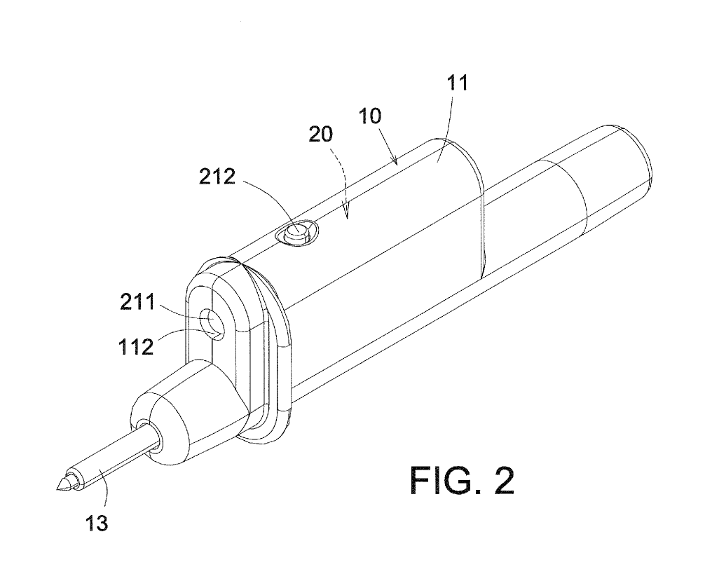

As shown in FIGS. 1 and 2, the body member 11 contains a chamber 111 within which the light generation member 20 and a test pin 13 are installed. The test probe 13 protrudes from a front side of the body member 11. Also on the front side of the body member 11 is a front opening 112 through which the light from the light generation member 20 is projected. The light generation member 20 contains a light generation circuit 21 with a light generation element 211 and a switch element 212. A control means 212a of the switch element 212 is exposed outside the body member 11 through which the light generation element 211 is turned on and off.

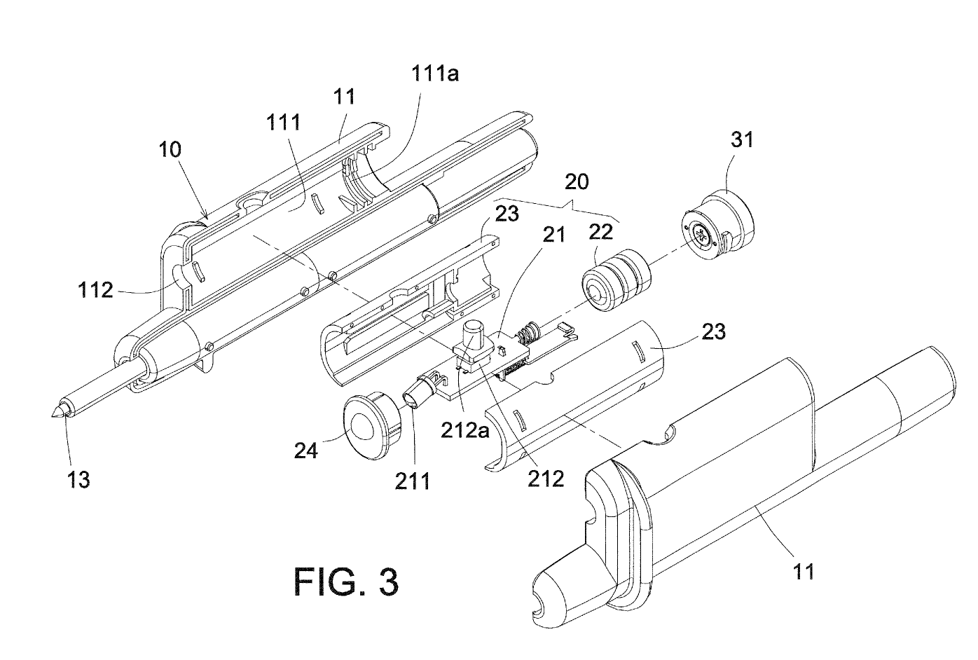

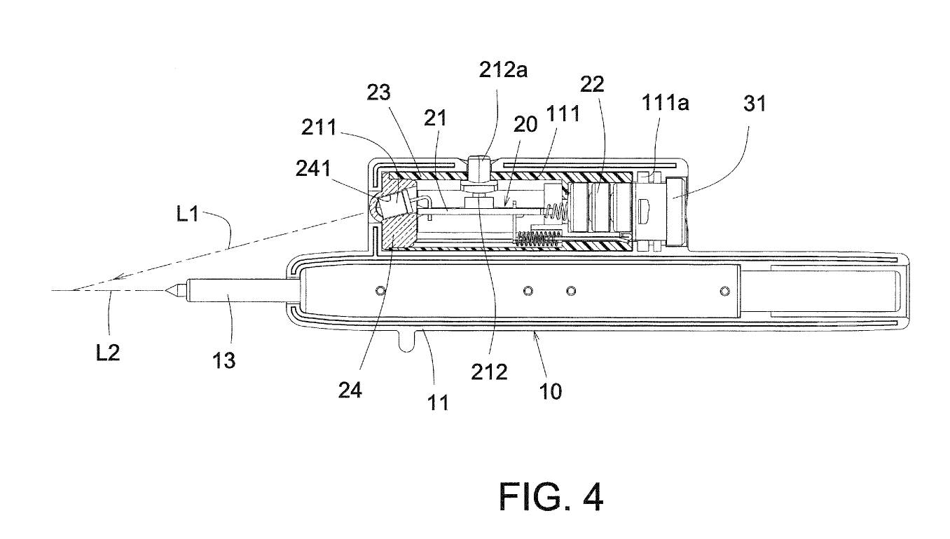

As shown in FIGS. 3 and 4, in an alternative embodiment, the light generation member 20 further contains a casing element 23 where the light generation circuit 21 and a battery pack 22 are housed. As in the previous embodiment, the light generation circuit 21 has a light generation element 211 and a switch element 212 whose control means 212a is exposed outside the casing element 23 and the body member 11 for turning on and off the light generation element 211.

For the foregoing embodiments, a light guiding element 24 is positioned between the front opening 112 and the light generation element 211 for focusing and directing the light from the light generation element 211 to project forward. The light guiding element 24 has a compartment 241 for accommodating the light generation element 211.

As shown in FIG. 4, the light generation element 211 is aimed along a direction L1 while the test pin 13 is extended along another direction L2. The directions L1 and L2 intersect at a point at a distance in front of the test pin 13.

Inside the chamber 111, threads 111a are provided adjacent to a back opening on a back side of the body member 11. The back opening is for the placement and replacement of the battery pack 22 and is screwed shut by a plug 31 so as to seal the light generation member 21 inside the chamber 111.

As described above, by engaging the control means 212a to turn on the light generation element 211 to project light in front of the test pin 13, the test probe 10 could be operated conveniently in the dark.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A test probe with illumination, comprising:
a body member having a chamber with a front opening;
a test pin extended from said body member; and
a light generation member inside said chamber, said light generation member having a battery pack and a light generation circuit powered by said battery pack; said light generation circuit having a light generation element and a switch element, and a control means of said switch element exposed outside of said body member.

2. The test probe with illumination according to claim 1, wherein a light guiding element is positioned between said front opening and said light generation element for focusing and direction said light generation element's light forward.

3. The test probe with illumination according to claim 2, wherein said light guiding element has a compartment accommodating said light generation element.

4. The test probe with illumination according to claim 1, wherein said light generation element's light is projected along a first direction; said test pin is extended along a second direction; and said first and second directions intersect at a point at a distance in front of said test pin.

5. The test probe with illumination according to claim 1, wherein said chamber has a back opening opposite to said first opening; a plurality of threads are provided inside said chamber around said back opening; and said back opening is as such screwed shut by a plug.

6. A test probe with illumination, comprising:
a body member having a chamber with a front opening;
a test pin extended from said body member; and
a light generation member inside said chamber, said light generation member having a battery pack, a light generation circuit powered by said battery pack, and a casing element housing said battery pack and said light generation circuit; said light generation circuit having a light generation element and a switch element, and a control means of said switch element exposed outside of said body member.

7. The test probe with illumination according to claim 6, wherein a light guiding element is positioned between said front opening and said light generation element for focusing and direction said light generation element's light forward.

8. The test probe with illumination according to claim 7, wherein said light guiding element has a compartment accommodating said light generation element.

9. The test probe with illumination according to claim 6, wherein said light generation element's light is projected along a first direction; said test pin is extended along a second direction; and said first and second directions intersect at a point at a distance in front of said test pin.

10. The test probe with illumination according to claim 6, wherein said chamber has a back opening opposite to said first opening; a plurality of threads are provided inside said chamber around said back opening; and said back opening is as such screwed shut by a plug.
